(19) United States
(12) Patent Application Publication
(10) Pub. No.: US 2007/0161516 A1
(43) Pub. Date: Jul. 12, 2007

(54) FILTRATE REDUCER FOR DRILLING MUDS

(75) Inventors: Stefania Vecchi, Albizzate (IT); Christina Demarchi, Oleggio (IT); Laura Vigano, Albizzate (IT); Giuseppe Li Bassi, Gavirate (IT); Dario Chiavacci, Albizzate (IT)

Correspondence Address: PAUL S MADAN;MADAN, MOSSMAN & SRIRAM, PC, 2603 AUGUSTA, SUITE 700, HOUSTON, TX, 77057-1130, US

(73) Assignee: LAMBERTI SPA, Albizzate (IT)

(21) Appl. No.: 11/615,475

(22) Filed: Dec. 22, 2006

(30) Foreign Application Priority Data
Dec. 23, 2005 (IT) VA2005A000074

(51) Int. Cl. C09K 8/00; E21B 43/00

(52) U.S. Cl. 507/121; 507/226

(57) ABSTRACT

An additive for reducing filtrate loss may be obtained by the reaction of carboxymethyl cellulose with an ethylenically unsaturated monomer containing a sulfonic group in the form of acid or salt thereof. The product of the reaction useful in water-based drilling muds which are employed in the drilling and/or completion of oil wells. The additive exhibits its characteristic function of filtrate reduction even at high temperature and pressure conditions; and, moreover, it is suitable for application in the presence of salts and solids.

### CROSS REFERENCE TO RELATED APPLICATION

This Application claims priority from Italian Patent Application Number IT-VA2005A000074 which was filed on Dec. 23, 2006.

### BACKGROUND OF THE INVENTION 1. Field of the Invention

The present invention relates to an additive for reducing filtrate loss (Filtrate Reducer) for use in drilling muds employed in the drilling and completion of oil and gas wells. The present invention particularly relates to a Filtrate Reducer that is useful at high temperature and pressure conditions; and in the presence of salts and solids.

2. BACKGROUND OF THE ART

Drilling muds, which are also called drilling fluids, are complex mixtures of chemicals used in drilling operations for the production of hydrocarbons and natural gas from subterranean reservoirs. Typically, oil and gas wells are drilled using drilling equipment in the presence of a drilling fluid.

Drilling fluids, generally comprising a liquid or a solid suspension in a dispersing liquid phase, are pumped inside the drilling shaft and exit from the drilling bit through small openings. The drilling fluids return to the surface through the small annulus between the outside of the drilling shaft and the bore hole wall.

Drilling muds perform a number of functions. Exemplary of these functions are carrying drill cuttings up to the surface and suspending them when the fluid circulation is stopped; cooling and lubricating the drill bit; creating hydrostatic pressure to avoid uncontrolled blow outs and to help supporting the weight of the bore hole walls; and acting as lubricant between the drilling bit and the bore hole walls. Drilling fluids, moreover, create on the bore hole walls and eventually on the surface of porous geological formations a filter cake having low permeability. The liquid permeating the filter cake and the formation is called “filtrate”.

If the amount of filtrate passing into the formation (filtrate loss) is high, the composition of the drilling fluid itself changes, and this causes loosing control of fluid proprieties. A large fluid loss can cause the deposition of a thick filter cake on the bore hole walls that reduces the diameter of the well bore.

For all these reasons, it is generally desirable that the drilling fluid exhibits a low level of filtrate loss. It is especially desirable that the drilling fluid exhibit a low level of filtrate loss while having specific rheological characteristics of viscosity, plasticity and thixotropy to promote the removal and carrying away of drill cuttings.

Water-based drilling fluids are generally made of dispersions of clays, such as bentonite; of weighting materials, such as barite; and of other additives, in water or in concentrated salted aqueous solutions. The role of the additives is to regulate rheology, to control pH, improve lubricity, reduce solid depositions on equipment, limit bacterial growth and corrosion, decrease shale hydration and swelling, and to control filtrate loss.

Many conventional filtrate reducers have been used to control the filtrate in drilling fluids and to minimize the liquid loss through the formation. These conventional filtrate reducers are used to inhibit the porosity of the filter cake. Exemplary conventional filtrate reducers include starch, modified starch, cellulose and its derivatives, lignin and its derivatives, and synthetic polymers such as acrylic acid, methacrylic acid and acrylamide copolymers.

The above cited conventional filtrate reducers suffer from well known limitations in applications for the production of oil and gas. For example, polyacrylates and polyacrylamide show relevant limitations in the presence of high concentrations of salts or of contamination with bivalent cations. Starch and cellulose derivatives are not stable in the high temperature and high pressure conditions of deep wells, where temperature may easily rise up to 190° C. (375° F.) and above.

Therefore it would be desirable in the art of drilling oil and gas wells to have drilling fluid additives which are efficient also at high temperature, i.e. at temperature above 150° C. (300° F.), and whose action is not influenced by solids and salts contamination. Such additives, hereinafter Filtrate Reducers, which efficiently perform their functions at these conditions are often referred to in the art as “HPHT Filtrate Reducers”.

it has now been found that by reacting carboxymethyl cellulose with an ethylenically unsaturated monomer containing a sulfonic group in the form of an acid or salt, in specific ratios and conditions, a Filtrate Reducer is obtained obviating many typical disadvantages of prior art additives.

### SUMMARY OF THE INVENTION

in one embodiment, the present invention is a grafted copolymer obtained from the reaction of from 40% to 90% by weight of carboxymethyl cellulose having a DS (degree of substitution) of from 0.6 to 1.2; and from 10 to 60% by weight of ethylenically unsaturated monomers containing a sulfonic group in the form of an acid and/or salt. The resulting copolymer can be used as a Filtrate Reducer for water-based drilling fluids that are particularly efficient even at high temperature and high pressure conditions and in the presence of salts and solids.

In another embodiment, the invention is a procedure for the preparation of a Filtrate Reducer for water-based drilling fluids comprising the steps of: (1) mixing from 40 to 90% by weight of carboxymethyl cellulose having DS from 0.6 to 1.2 and an initiator of radical polymerization at temperature below 30° C.; (2) admixing therewith with stirring from 10 to 60% by weight of ethylenically unsaturated monomers containing a sulfonic group in the form of acid and/or salt; and (3) heating the resulting admixture to 60-75° C. to initiate the reaction and maintaining this temperature for from about 0.5 to about 4 hours. The thus obtained Filtrate Reducer is dried and ground to form a powder.

In still another embodiment, the present invention a method for reducing filtrate loss during oil and gas drilling operations, or in the subsequent completing or cementing operations of an oil or gas well, comprising the use of a water-based drilling fluid containing from 0.05 to 3% by weight of the above described Filtrate Reducer.

Another embodiment of the invention is a water-based drilling fluid containing from 0.05 to 3% by weight of the above described Filtrate Reducer.

### DETAILED DESCRIPTION OF THE INVENTION

The Filtrate Reducer of the invention is a copolymer of a carboxymethyl cellulose having a DS from 0.6 to 1.2 and ethylenically unsaturated monomers containing a sulfonic group in the form of an acid and/or salt. While not wishing to be bound by any theory, it is believed that the Filtrate Reducer of the present invention is primarily a carboxymethyl cellulose grafted with the ethylenically unsaturated monomer, even if it cannot be excluded that it also may contain a minor amount of a homopolymer deriving from the unsaturated monomer.

A carboxymethyl cellulose graft polymer with of an ethylenically unsaturated sulphonic acid, 2-acrylamido-2-methylpropane sulfonic acid (AMPS), is described in Hitoshi Kubota et al., “Factors affecting liquid-phase photografting of acrylic acid on cellulose and its derivatives”, European Polymer Journal, 33, (1), 67-71, 1997; nonetheless, the carboxymethyl cellulose used as substrate is not water soluble, having degree of substitution (DS) of 0.1; moreover, in the preparation Methylenebisacrylamide (MBAA) is used as a cross-linker. The obtained polymer is therefore a ter-polymer of carboxymethyl cellulose, AMPS and MBAA.

U.S. Pat. No. 5,075,401, filed in 1989 and assigned to Allied Colloids, describes a method to obtain polymers from a substrate, such as carboxymethyl cellulose, dextran and starch, with ethylenically unsaturated monomers, by using both an oxidizing metal and a peroxy compound; U.S. Pat. No. 5,075,401 also suggest that to obtain the desired high molecular weight, the amount of substrate shall be relatively low in respect of the monomer amount. The polymers of U.S. Pat. No. 5,075,401 are said to be useful as Filtrate Reducers.

U.S. Pat. No. 5,008,025 relates to an additive for water-based drilling fluids combining a vinyl polymer containing sulfonate groups and a polyanionic cellulose or carboxymethyl cellulose.

in one embodiment, the grafted copolymer of the invention has a Brookfield LVT viscosity at 60 rpm, 20° C. and 2% weight concentration of from 50 to 8,000 mPa·s. Brookfield viscosity is often determined using a Brookfield viscometer running at a specified rate at a specified temperature and with the sample tested at a specified concentration such as those listed above. In another embodiment, the Brookfield LVT viscosity is preferably between 50 and 500 mPa·s.

Contrary to some indications expressed by the prior art (see for example U.S. Pat. No. 4,131,576 and U.S. Pat. No. 4,696,996, where the difficulty of grafting a water soluble monomer, such as acrylic acid, on a water soluble or water dispersed polysaccharide substrate in the presence of water at high solid concentration condition is reported), the present invention provides the reaction product of ethylenically unsaturated sulfonated monomers and carboxymethyl cellulose obtained at high solid concentration condition. At high temperature, the capability of reducing filtrate loss of the grafted copolymers of the invention is remarkably higher than that shown by purified carboxymethyl cellulose, i.e. by carboxymethyl cellulose having active content above 95% by weight; at these conditions. The filtrate loss volumes, expressed in milliliters and measured according to the method described here below, are smaller than 100 and are remarkably better than those obtained by physically mixing carboxymethyl cellulose and homopolymer from ethylenically unsaturated monomer.

it has also been observed that the capability of reducing filtrate loss can be further enhanced by adding to the grafted copolymer from 5 to 10% by weight of an antioxidant, such as sodium thiosulfate, potassium thiosulfate, sodium sulfite or potassium sulfite. Therefore, in another embodiment, the invention is a Filtrate Reducer comprising from 90 to 98% by weight of the grafted copolymer of the invention and from 2 to 10% by weight of an antioxidant, preferably sodium thiosulfate.

The Filtrate Reducers of the invention are rapidly soluble in water-based muds. The wide spectrum of viscosity of the Filtrate Reducers of the invention allows for a simultaneous effect of filtrate loss reduction and mud thickening.

The procedure for the preparation of the Filtrate Reducer of the invention is particularly advantageous because it is industrially practicable and does not necessitate specific equipment. The method also avoids the use of organic solvents and/or surfactants and does not produce liquid or solid waste.

According to a preferred embodiment of the invention, the ethylenically unsaturated monomers in the form of an aqueous solution are added to carboxymethyl cellulose in the form of powder. The quantity of water in the reaction mixture does not exceeding the total weight of ethylenically unsaturated monomers and carboxymethyl cellulose. In yet another embodiment of the invention, the monomer may be used neat thus limiting or even eliminating the need for a drying step.

The carboxymethyl cellulose used in the procedure of the invention is medium viscosity carboxymethyl cellulose, i.e. carboxymethyl cellulose having a Brookfield LVT viscosity at 60 rpm, 20° C. and 2% weight concentration of between 1,000 and 10,000 mPa·s, and can be raw or purified carboxymethyl cellulose. Best results may be obtained with purified carboxymethyl cellulose.

For the most common applications, that is when the Filtrate Reducer does not need to perform also as a thickening agent, the utilisable carboxymethyl cellulose has Brookfield LVT viscosity at 60 rpm, 20° C. and 2% weight concentration of between 1,000 and 3,000 mPa·s.

The ethylenically unsaturated monomers containing a sulfonic group useful for the realization of the invention are: 2-acrylamido-2-methylpropanesulfonic acid (AMPS), allylsulfonic acid, vinylsulfonic acid, methallylsulfonic acid, p-styrenesulfonic acid, and mixture thereof. The use of AMPS as the sole monomer is particularly preferred. When 2-acrylamido-2-methylpropane sulfonic acid is used, especially interesting results are obtained by adding from 35 to 45% by weight of 2-acrylamido-2-methylpropane sulfonic acid sodium salt, in the form of 40 to 60% aqueous solution, the percentage being calculated on the total weight of carboxymethyl cellulose and 2-acrylamido-2-methylpropane sulfonic acid sodium salt.

The initiator of radical polymerization is chosen among the normally utilized initiators such as ammonium persulfate, sodium persulfate, potassium persulfate, benzoyl peroxide, lauryl peroxide, azodiisobutyronitrile, redox couples such as ter-butyl hydroperoxide and sodium metabisulfite. It is preferably added at a temperature of between 10 and 25° C., in such a quantity that the weight ratio between initiator and ethylenically unsaturated monomer is between 0.003 and 0.006. Preferably, in some embodiments, the initiator is ammonium persulfate in the form of powder.

in one embodiment, the invention is a procedure for the preparation of a Filtrate Reducer for water-based drilling fluids comprising the steps of:
i. from 40 to 90% by weight of carboxymethyl cellulose, having a DS of from 0.6 to 1.2 and Brookfield LVT viscosity at 60 rpm, 20° C. and 2% weight concentration comprised of from about 1,000 to about 10,000 mPa·s, and an initiator of radical polymerization are mixed together at temperature below 30° C.;
ii. from 10 to 60% by weight of ethylenically unsaturated monomers containing a sulfonic group in the form of acid and/or salt are added under stirring;
iii. the temperature is raised to 60-75° C. to initiate the reaction and it is maintained for 0.5-4 hours; and
iv. the thus obtained Filtrate Reducer is dried and ground to form a powered.

Before step ii of the procedure of the invention takes place, the reaction medium is purged with nitrogen to inhibit the inactivation of radical species by atmospheric oxygen. Preferably, the reaction of step iii is maintained at 60-75° C. for about 1 hour. Drying and grinding are performed with conventional methods. In addition to grinding, the grafted copolymers of the invention may be prepared for use using any method known to those of ordinary skill in the art of preparing such grafted copolymers. For example, in one embodiment, the grafted copolymers may be converted into pellets by prilling. In an alternative embodiment, the grafted copolymers may be prepared by extrusion into strands and chopping.

A further advantage of the procedure of the present invention is that it is not necessary to separate the reaction product by precipitation. Furthermore, the Filtrate Reducer of the invention, showing excellent performances, can be used directly without any need of washing or purification.

Filtrate Loss Test

in order to evaluate the filtrate loss reduction performance of the Filtrate Reducers of the invention and of Filtrate Reducers of the prior art the test described here below was carried out.

A suspension simulating a drilling fluid is prepared as per the following formulation, by means of a Multimixer ® Model 9B with 9B29X impellers or equivalents by adding in sequence the following products:
Saturated sodium chloride aqueous solution (CAS No. 7647-15-5): 350 cm³ ±5 cm³;
API Standard Evaluation “Base Clay” (conforming to API specification 13A, XVI edition, February 2004, § 4.2.5): 35 g; and
NaHCO3 (CAS No. 144-55-8): 1.0±0.1 g.

After stirring 10 minutes, the Filtrate Reducer (5.0±0.1 g) is added and the mixture is stirred 20 minutes more. The obtained suspension is placed in a hot rolling cell. The cell is sealed and rolled for 16 hours in a pre-heated oven at 193° C. (API RP 131, VII edition, February 2004, § 20.5). This treatment simulates the thermal stress applied to the mud during the recycling in the well.

After the rolling period is completed, the cell is removed from the oven and cooled to room temperature in a cold water-bath. The cell is opened, the suspension poured into a filter press cell and the filtrate volume is determined at 25° C.±1° C. and 690 KPa±35 KPa. The filtrate loss volume (referred to as FLc in the following tables) is expressed in millilitres. A lower value for FLc indicates better performance of the Filtrate Reducer as compared to a higher value.

The following examples are provided to illustrate the present invention. The examples are not intended to limit the scope of the present invention and they should not be so interpreted. amounts are in weight parts or weight percentages unless otherwise indicated.

### EXAMPLE 1

6 Kg of purified carboxymethyl cellulose having 98% dry basis active content, a degree of substitution of 0.88, 6.9% a water content of 6.9%, and Brookfield LVT viscosity of 1080 mPa·s at 2% in deionized water at 20° C. and 60 rpm (CMC1); were placed in a reactor and mechanically mixed for 10 minutes at 20° C. with 19.6 grams of an ammonium persulfate initiator under a nitrogen purge/pad to remove oxygen. 8 kg of 50% water solution of 2-acrylamido 2-methylpropanesulfonic acid sodium salt were added in 25 minutes to the blend of carboxymethyl cellulose and initiator while keeping the temperature at 19°-20° C. under continuous stirring.

The reaction mixture was heated at 65°-70° C. and held at this temperature under stirring for 30 minutes. The reaction mixture was then heated to 70°-75° C. and held at this temperature for 60 minutes.

The mixture was cooled to 45° C. and then unloaded, dried and subjected to grinding to give the Filtrate Reducer RF1.

The Brookfield LVT viscosity at 60 rpm and 20° C. of RF1 is 225 mPa—s in a 2% deionized water solution.

### COMPARATIVE EXAMPLE 2

A homopolymer of 2-acrylamido 2-methylpropanesulfonic acid sodium salt was synthesized by reacting a 40% water solution of AMPS sodium salt in the presence of sodium metabisulfite and ammonium persulfate at 70° C. The resulting homopolymer was isolated, dried and mixed with 6 parts by weight of CMC1 to give the Filtrate Reducer RF1 mix.

The Brookfield LVT viscosity at 60 rpm and 20° C. of RF1 mix is 159 mPa·s in a 2% deionized water solution.

The filtrate loss volumes (FLc) of CMC1, RF1 and RF1 mix are determined and are shown in the following table (Table 1).

TABLE 1
Measurement of the Filtrate Loss
on products from Examples 1 and 2

| Sample ID | FL_{C} (ml) |
|---|---|
| RF1 | 23 |
| CMC1 | 134 |
| RF1mix | 112 |

The filtrate loss volume of RF1 was also measured carrying out the test on a suspension where a small amount of sodium thiosulfate (0.3 grams) was added. The result was 11 ml.

### Gel Permeation Chromatography Analysis on Products from Examples 1 and 2

The GPC (Gel Permeation Chromatography) analysis of RF1 shows a single peak, whose average molecular weight is about 390,000 Dalton. The same analysis run on CMC1 gives an average molecular weight of about 300,000 Dalton, with reference to GPC universal calibration curve. In the Filtrate Reducer of the invention (RF1) the presence of relevant amounts of polymer having an average molecular weight higher than that of starting carboxymethyl cellulose, confirms the fact that the reaction of the invention leads to the formation of a graft copolymer of carboxymethyl cellulose. GPC also confirmed the presence of two separate peaks with different molecular weight in the RF1 mix.

### Thermal Gravimetric Analysis on Products from Examples 1 and 2 at Variable Temperature

A comparative thermal gravimetric determination of CMC1, RF1 and RF1 mix was made by using TGA (Thermal Gravimetric Analysis), an analysis that allows the measurement of the weight loss of samples as a function of the temperature increase and time. For the thermal gravimetric determination, the samples have been previously dried and conditioned overnight in vacuum oven at 50° C. A SETARAM 92-12 instrument was used for the measurements. The thermogravimetric curves were obtained in air atmosphere by setting the temperature increase at 10° C. per minute; the weight loss is related to temperature.

It was observed that CMC1 shows a quick weight loss, over 50%, between 250° and 300° C., while the weight loss of RF1 is lower and occurs in a wider and higher range of temperature, between 270° and 400° C. It was also observed that in the range between 150° and 200° C., (high temperature working condition for a Filtrate Reducers), RF1 shows the lowest weight loss.

### “Hot rolling” Test on the Products of Examples 1 and 2 at Fixed Temperature

Three 2% solutions were prepared in saturated salted water (NaCl saturated water) with samples from CMC1, RF1 and RF1 mix. The solutions, respectively named sCMC1, sRF1 and sRF1 mix, were placed in three sets of hot rolling cells (API RP 13I-VlI ed.-February 2004, § 20.6) and constantly rolled in an oven for 16 hours at 25°, 90° and 193°. The appearance of the solutions at the end of the hot rolling test is reported in Table 2.

TABLE 2
Hot Rolling Test Results

| T° | sCMC1* | sRF1 | sRF1mix* |
|---|---|---|---|
| 25° C. | homogeneous | homogeneous | homogeneous |
| | colorless | yellowish | yellowish |
| 90° C. | homogeneous | homogeneous | not homogeneous |
| | colorless | dark yellow | yellowish with |
| | | | precipitation of |
| | | | black particles |
| 193° C. | not homogeneous | homogeneous | not homogeneous |
| | with separation of | orange-yellow | with separation of |
| | black particles partly | | black particles |
| | settled and partly | | partly settled and |
| | floating | | partly floating |

comparative solutions

### EXAMPLE 3

750 grams of raw carboxymethyl cellulose having a 75% dry basis active content, a DS of 0.97, and a Brookfield LVT viscosity at 60 rpm and 20° C. of 500 mPa·s in 2% deionized water solution (CMC2), were placed in a reactor and mechanically mixed at 20° C. with 1.52 g of ammonium persulfate for 10 minutes under a nitrogen purge/pad. 680 g of a 50% water solution of 2-acrylamido 2-methylpropanesulfonic acid sodium salt were added over 10 minutes to the blend of carboxymethyl cellulose and initiator while keeping the temperature at 19°-20° C. using continuous stirring.

The reaction mixture was heated to 65°-70° C. and held at this temperature under stirring for 30 minutes. The reaction mixture was then heated to 70°-75° C. and held for 60 minutes at this temperature. The mixture was cooled to 45° C. and dried to remove excess moisture and subjected to grinding to give the Filtrate Reducer RF2.

The Brookfield LVT viscosity at 60 rpm and 20° C. of RF2 is 71 mPa·s in 2% deionized water solution. A Filtrate Reducer is prepared by mechanically mixing 94 parts by weight of RF2 and 6 parts by weight of sodium thiosulfate, to obtain the Filtrate Reducer RF2t.

### COMPARATIVE EXAMPLE 4

A homopolymer of 2-acrylamido 2-methylpropanesulfonic acid sodium salt was synthesized by reacting a 42% water solution of AMPS sodium salt in the presence of sodium metabisulfite at 75° C. The resulting homopolymer was isolated, dried and mixed with 6.2 parts by weight of CMC2, to give the Filtrate Reducer RF2mix.

The Brookfield LVT viscosity at 60 rpm and 20° C. of RF2mix is 188 mPa·s in 2% deionized water solution.

The filtrate loss volumes (FL_{c}) of CMC2, RF2t and RF2mix are shown in Table 3.

TABLE 3
Measurement of the Filtrate Loss
on products from Examples 3 and 4

| Sample ID | FL_{C} (ml) |
|---|---|
| RF2t | 35 |
| CMC2 | 145 |
| RF2mix | 98 |

### EXAMPLE 5

750 g of purified carboxymethyl cellulose having a DS of 1.0 and a Brookfield LVT viscosity at 60 rpm and 20° C. of 8,000 mPa·s at 2% in deionized water (CMC3), were placed in a reactor and mechanically stirred at 20° C. with 2.13 g of ammonium persulfate over 10 minutes under a nitrogen pad/purge. 952 g of a 50% water solution of 2-acrylamido 2-methylpropanesulfonic acid sodium salt were slowly added over 10 minutes to the mixture of carboxymethyl cellulose and initiator while keeping the temperature at 19°-20° C. under continuous stirring.

The reaction mixture was heated at 65°-70° C. and kept at this temperature under stirring for 30 minutes. The reaction mixture was then heated to 70°-75° C. and kept at that temperature for 60 minutes. The mixture was cooled to 45° C. then dried to remove excess of moisture and subjected to grinding to give the Filtrate Reducer RF3.

The Brookfield LVT viscosity at 60 rpm, 20° C. of RF3 is 6,000 mPa·s in a 2% deionized water solution.

A Filtrate Reducer was prepared by mechanically mixing 94 parts by weight of RF3 and 6 parts by weight of sodium thiosulfate to obtain the Filtrate Reducer RF3t.

### COMPARATIVE EXAMPLE 6

A homopolymer of 2-acrylamido 2-methylpropanesulfonic acid (AMPS) sodium salt was synthesized by polymerizing a 42% water solution of AMPS sodium salt in the presence of sodium metabisulfite and ammonium persulfate at about 75° C.

The resulting homopolymer was isolated, dried and mixed with 6.1 parts by weight of CMC3, to obtain the Filtrate Reducer RF3 mix.

A Filtrate Reducer was prepared by mechanically mixing 94 parts by weight of RF3mixt with 6 parts by weight of sodium thiosulfate, to obtain the Filtrate Reducer RF3 mix.

Another Filtrate Reducer is prepared by mechanically mixing 94 parts by weight of CMC3 with 6 parts by weight of sodium thiosulfate, to obtain the Filtrate Reducer CMC3t.

The filtrate loss volumes (FL_{c}) of CMC3t, RF3t and RF3mixt are shown in Table 4.

TABLE 4
Measurement of the Filtrate Loss
on Products from Examples 5 and 6

| Sample ID | FL_{C} (ml) |
|---|---|
| RF3t | 31 |
| CMC3t | 125 |
| RF3mixt | 100 |

1. A grafted copolymer comprising the product obtained from the reaction of:
a) from about 40% to about 90% by weight of carboxymethyl cellulose having a degree of substitution (DS) of from about 0.6 to about 1.2; and
b) from about 10 to about 60% by weight of at least one ethylenically unsaturated monomer containing a sulfonic group in the form of acid and/or salt.

2. The grafted copolymer of claim 1, wherein the at least one ethylenically unsaturated monomer is 2-acrylamido-2-methylpropane sulfonic acid sodium salt.

3. The grafted copolymer of claim 1 having a Brookfield LVT viscosity at 60 rpm, 20° C. and 2% weight concentration of from about 50 to about 8,000 mPa·s.

4. The grafted copolymer of claim 3 having a Brookfield LVT viscosity at 60 rpm, 20° C. and 2% weight concentration of from about 50 to about 500 mPa·s.

5. A procedure for the preparation of a grafted copolymer for use as a Filtrate Reducer for water-based drilling fluids comprising the steps of:
i. mixing from about 40 to about 90% by weight of carboxymethyl cellulose having a DS of from about 0.6 to about 1.2 and a Brookfield LVT viscosity at 60 rpm, 20° C. and 2% weight concentration of from about 1,000 to about 10,000 mPa·s; and a radical polymerization initiator at a temperature below about 30° C. to form a first reaction mixture;
ii. admixing with the first reaction mixture from about 10 to about 60% by weight of at least one ethylenically unsaturated monomer containing a sulfonic group in the form of acid and/or salt under stirring to form a second reaction mixture;
iii. heating the second reaction mixture to about 60-75° C. to initiate a polymerization reaction and maintaining the second reaction mixture at about 60-75° C. for from about 0.5 to about 4 hours to produce a product graft copolymer.

6. The procedure of claim 5, additionally comprising a step:
iv. recovering the product graft copolymer of step iii and subjecting the product to grinding to produce a Filtrate Reducer.

7. The procedure of claim 5, wherein:
the at least one ethylenically unsaturated monomer is in the form of an aqueous solution and is added to carboxymethyl cellulose which is in the form of powder; and
the quantity of water in the reaction mixture does not exceed the total weight of ethylenically unsaturated monomers and carboxymethyl cellulose.

8. The procedure of claim 7 additionally comprising a step:
iv. recovering the product graft copolymer of step iii by drying and subjecting the product to grinding to produce a Filtrate Reducer.

9. The procedure of claim 8, wherein the at least one ethylenically unsaturated monomer is 2-acrylamido-2-methylpropane sulfonic acid.

10. The procedure of claim 9, wherein the 2-acrylamido-2-methylpropane sulfonic acid sodium salt is in the form of a 40 to 60% aqueous solution and the 2-acrylamido-2-methylpropane sulfonic acid sodium salt is present at a concentration of from about 35 to about 45% by weight of the total weight of carboxymethyl cellulose and 2-acrylamido-2-methylpropane sulfonic acid sodium salt.

11. The procedure of claim 10, wherein the carboxymethyl cellulose has a Brookfield LVT viscosity at 60 rpm, 20° C. and 2% weight concentration of from about 1,000 to about 3,000 mPa·s.

12. A Filtrate Reducer for water-based drilling fluids comprising a grafted copolymer obtained from the reaction of:
a) from about 40% to about 90% by weight of carboxymethyl cellulose having a DS of from about 0.6 to about 1.2; and
b) from about 10 to about 60% by weight of ethylenically unsaturated monomers containing a sulfonic group in the form of acid and/or salt.

13. The Filtrate Reducer of claim 12, comprising from about 90 to about 98% by weight of the grafted copolymer and from about 2 to about 10% by weight of an antioxidant.

14. The Filtrate Reducer of claim 13, wherein the antioxidant is sodium thiosulfate.

15. A method for reducing filtrate loss in the exploration for and/or production of oil and gas comprising using a water-based drilling fluid containing from about 0.05 to about 3% by weight of a Filtrate Reducer of claim 12.

16. The method of claim 15 wherein the drilling fluid is used in the initial drilling of an oil well.

17. The method of claim 15 wherein the drilling fluid is used in an extant oil well during completion or cementing operations

18. The method of claim 15, wherein the Filtrate Reducer is prepared using at least one ethylenically unsaturated monomer and the at least one ethylenically unsaturated monomer is 2-acrylamido-2-methylpropane sulfonic acid sodium salt.

19. A water based drilling fluid containing from about 0.05 to about 3% by weight of a Filtrate Reducer of claim 12.

20. The water based drilling fluid of claim 19 wherein the Filtrate Reducer is obtained from the reaction of:
a) from about 55% to about 65% by weight of carboxymethyl cellulose having DS from about 0.6 to about 1.2; and
b) from about 35 to about 45% by weight of 2-acrylamido-2-methylpropane sulfonic acid sodium salt.
